(19) United States
(12) Patent Application Publication
(10) Pub. No.: US 2006/0023735 A1
(43) Pub. Date: Feb. 2, 2006

(54) Versatile low power driver for gigabit ethernet systems

(76) Inventor: Nir Sasson, Eyn-Sarid (IL)

Correspondence Address: TEXAS INSTRUMENTS INCORPORATED, P O BOX 655474, M/S 3999, DALLAS, TX, 75265, US

(21) Appl. No.: 11/191,261

(22) Filed: Jul. 27, 2005

Related U.S. Application Data
(60) Provisional application No. 60/592,304, filed on Jul. 28, 2004.

(51) Int. Cl. H04L 12/413; H04L 12/66

(52) U.S. Cl. 370/445; 370/463

(57) ABSTRACT

The present invention provides a system for optimizing transmission output power for a Gigabit Ethernet communications system (100). A PHY operational layer (104) is provided, with a backoff construct (102) that is at least partially implemented within the PHY operational layer. A second end component (108) is communicatively coupled to the PHY operational layer. An estimating construct (110) is implemented within the PHY operational layer, and is cooperatively associated with the backoff construct. The estimating construct determines whether the second end component is at a short or a long distance and, responsive to that determination, the backoff construct adjusts transmit output voltage swing.

### PRIORITY CLAIM

This application claims priority of U.S. Provisional Application No. 60/592,304, filed Jul. 28, 2004.

### TECHNICAL FIELD OF THE INVENTION

The present invention relates generally to the field of digital voice and data communications and, more particularly, to a versatile, low-power line driver system for Gigabit Ethernet applications.

### BACKGROUND OF THE INVENTION

Among digital communication technologies, Ethernet has been a popular networking protocol for a number of years. Over those years, efforts have been made to advance Ethernet performance. For example, Fast Ethernet increased Ethernet speed from 10 to 100 megabits per second (Mbps). More recently, Gigabit Ethernet (GE) builds on top of the Ethernet protocol—increasing speed tenfold over Fast Ethernet to 1000 Mbps, or 1 gigabit per second (Gbps). Ethernet-based protocols are prevalent throughout a wide variety of high-speed local area network backbones and server systems.

In order to accelerate speeds from 100 Mbps Fast Ethernet up to 1 Gbps, several changes need to be made to the physical interface of GE. Industry standards have settled for the proposition that GE should look identical to Ethernet from the data link layer upward. Challenges involved in accelerating to 1 Gbps have been resolved by merging two technologies together: IEEE 802.3 Ethernet and ANSI X3T11 FibreChannel.

By effectively combining these two technologies, GE utilizes take advantage of the existing high-speed physical interface technology of FibreChannel, while maintaining the IEEE 802.3 Ethernet frame format, backward compatibility for installed media, and use of full- or half-duplex carrier sense multiple access collision detect (CSMA/CD). This scenario helps minimize the technology complexity, resulting in a stable technology that can be quickly developed or adapted.

GE core power consumption in conventional implementations may range from 500-900 mW per port. A GE core typically consumes power from a chip's voltage supply (digital and analog) and, in specific implementations, may consume additional power from a central tap of an external transformer. However, on-chip power consumption constraints usually limit the number of ports that can be integrated on single device. Hence, reducing power consumption of single port is critical to further system performance improvements.

Conventional GE systems typically do not utilize any transmit output power backoff during non-transmit operations. With no power backoff, voltage requirements for the GE system are derived from a worst-case, non-optimal scenario. Such scenarios generally increase line driver power consumption, without achieving a significant performance gain.

As a result, there is a need for a system that provides a power backoff scheme to reduce inefficient transmit power consumption in an advanced Ethernet technology—such as Gigabit Ethernet—while providing efficient and reliable communications in an easy, cost-effective manner.

### SUMMARY OF THE INVENTION

The present invention provides a versatile power backoff system, comprising various constructs and methods, for reduce inefficient transmit power consumption in advanced Ethernet technologies—such as Gigabit Ethernet—and other similar technologies. Embodiments of the present invention provide a reduced power consumption line driver, which reduces PHY power consumption. The system of the present invention is readily implemented in a number of operational and physical embodiments, providing efficient and cost-effective optimization of a communication system's performance.

Specifically, the present invention provides a low-power transmitter mode system—a transmit power back-off scheme for 10/100/1000Base-T applications. This scheme significantly reduces the transmit (Tₓ) output swing for short transmission distances, and uses a high voltage swing for long transmission distances. In a short transmission distance, Tx swing is low (<<1 Volt), and Rx voltage is high (>>1 Volt). In a long cable case, just the opposite is true. The system of the present invention decreases, relatively, draw on central tap voltage or analog supply voltage—providing a reduced power-consumption line driver.

More specifically, various embodiments of the present invention provide a system for optimizing transmission output power for a Gigabit Ethernet communications system. A PHY operational layer is provided, having a backoff construct that is at least partially implemented within the PHY layer. A second end component is communicatively coupled to the PHY operational layer. An estimating construct is implemented within the PHY layer, and is cooperatively associated with the backoff construct. The estimating construct determines whether the second end component is at a short or a long distance and, responsive to that determination, the backoff construct adjusts transmit output voltage swing.

Other features and advantages of the present invention will be apparent to those of ordinary skill in the art upon reference to the following detailed description taken in conjunction with the accompanying drawings.

### BRIEF DESCRIPTION OF THE DRAWINGS

For a better understanding of the invention, and to show by way of example how the same may be carried into effect, reference is now made to the detailed description of the invention along with the accompanying figures in which corresponding numerals in the different figures refer to corresponding parts and in which:

FIG. 1 provides an illustration depicting one embodiment of a GE system in accordance with certain aspects of the present invention.

### DETAILED DESCRIPTION OF THE INVENTION

While the making and using of various embodiments of the present invention are discussed in detail below, it should be appreciated that the present invention provides many applicable inventive concepts, which can be embodied in a wide variety of specific contexts. The present invention is hereafter illustratively described primarily in conjunction with the design and operation of a certain high-performance Ethernet systems—particularly Gigabit Ethernet (GE) systems. Certain aspects of the present invention are further detailed in relation to specific operational modes and standards. Although described in relation to such constructs and schemes, the teachings and embodiments of the present invention may be beneficially implemented with a variety of digital communications technologies. The specific embodiments discussed herein are, therefore, merely demonstrative of specific ways to make and use the invention and do not limit the scope of the invention.

The present invention provides a versatile power backoff system, comprising various constructs and methods, for reduce inefficient transmit power consumption in advanced Ethernet technologies—such as Gigabit Ethernet—and other similar technologies. Embodiments of the present invention provide a reduced power consumption line driver, which reduces PHY power consumption. The system of the present invention is readily implemented in a number of operational and physical embodiments, providing efficient and cost-effective optimization of a communication system's performance.

Specifically, the present invention provides a low-power transmitter mode system—a transmit power back-off scheme for 10/100/1000Base-T applications. This scheme significantly reduces the transmit (Tₓ) output swing for short transmission distances, and uses a high voltage swing for long transmission distances. In a short transmission distance application, Tx swing is low (<<1 Volt), and Rx voltage is high (>>1 Volt). In a long cable transmission distance application, just the opposite is true. The system of the present invention decreases, relatively, draw on central tap voltage or analog supply voltage—providing a reduced power-consumption line driver. The present invention thereby creates a trade-off between power reduction and area reduction—through which designers can optimize system performance in a desired manner.

As previously noted, in order to accelerate speeds from 100 Mbps Fast Ethernet up to 1 Gbps, several changes need to be made to the physical interface of GE. Industry standards set GE identical to Ethernet, from the data link layer upward. Certain challenges involved in accelerating to 1 Gbps have been resolved by merging two technologies—IEEE 802.3 Ethernet and ANSI X3T11 FibreChannel—together. By combining these two technologies, GE utilizes take advantage of the existing high-speed physical interface technology of FibreChannel, while maintaining the IEEE 802.3 Ethernet frame format, backward compatibility for installed media, and use of full- or half-duplex carrier sense multiple access collision detect (CSMA/CD). Thus, by its very nature, GE supports a variety of long and short transmission distances, with a primary tradeoff between cost and distance.

CSMA/CD refers to the protocol used by stations sharing a transmission medium, to arbitrate use of that medium. A sender has to “listen” to the medium. If no other source is transmitting, then a sender may transmit. If two senders start transmitting at the same time, then a collision is deemed to have occurred. Transmitting stations, therefore, have to listen to the medium for collisions while transmitting, and retransmit a packet after some time, if a collision occurs.

A physical media attachment (PMA) sub layer for GE is identical to the PMA for FibreChannel. A serializer/deserializer is responsible for supporting multiple encoding schemes, and allowing presentation of those encoding schemes to upper operational layers. Data entering the physical sub layer (PHY) will enter through the PMA and will need to support the encoding scheme appropriate to that media. The encoding scheme for FibreChannel is 8B/10B, designed specifically for fiber-optic cable transmission. GE uses a similar encoding scheme. The difference between FibreChannel and GE, however, is that FibreChannel utilizes 1.062-gigabaud signaling whereas GE utilizes 1.25-gigabaud signaling. A different encoding scheme is required for transmission over UTP. This encoding is performed by UTP or 1000BaseT PHY.

IEEE 802.3x standards are concerned with defining a flow-control mechanism for full-duplex Ethernet. This mechanism is set up between two stations on a point-to-point link. If a receiving station at the end becomes congested, it can send back a frame called a “pause frame” to the source at the opposite end of the connection, instructing that station to stop sending packets for a specific period of time. The sending station waits the requested time before sending more data. The receiving station can also send a frame back to the source with a time-to-wait of zero, instructing the source to begin sending data again.

This flow-control mechanism was developed to match the sending and receiving device throughput. For example, a server can transmit to a client at a rate far in excess of the client's ability to accept packets, due to CPU interrupts, excessive network broadcasts, or multitasking within the system. In such instances, a client sends out a pause frame and requests that the server delay transmission for a certain period of time.

The PHY layer of GE utilizes a mixture of proven technologies from original Ethernet and ANSI X3T11 FibreChannel specifications. GE supports 4 physical media types, as defined in 802.3z (1000Base-X) and 802.3ab (1000Base-T). The 1000Base-X standard is based on the FibreChannel Physical Layer. 1000Base-T is a standard for GE over long-haul copper UTP.

Within the PHY layer physical implementations of a GE component, there are a number of performance concerns and tradeoffs that may impact the operation of a given GE system or component. As previously noted, GE core power consumption in conventional implementations may range from 500-900 mW per port. A GE core typically consumes power from a chip's voltage supply (digital and analog) and, in specific implementations, may consume additional power from a central tap of an external transformer. However, on-chip power consumption constraints usually limit the number of ports that can be integrated on single device. Hence, reducing power consumption of single port is critical to further system performance improvements.

A line driver of a given Tx path within a GE system may have significant power consumption issues. There are several conventional line driver architectures that differ in the amount silicon area and power they consume. Such architectures include current mode line drivers, voltage mode line drivers, and synthesized impedance voltage mode line drivers.

Considering, momentarily, certain aspects of such conventional architectures, the present invention comprehends several issues inherent therein. Voltage mode line drivers require a swing from an amplifier to be twice the voltage at a transformer output, due to some large resistance network typically used in series. However, due to low output impedance of such an amplifier, its output voltage does not change due to a receiving (Rx) signal. Current mode and synthesized impedance voltage mode line drivers require delivering voltage that is equal to voltage on a transformer output—not twice the value thereof. However, both such architectures are subject to an impact from an Rx signal.

For example, an Rx signal may be absorbed in a high impedance voltage mode line driver, and thereby require an increase in analog voltage supply to the related circuitry. As an example, GE specifications for 1000M mode require delivery of a 2Vₚₚ output swing, regardless of cable length. For the types of line drivers listed, this typically results in V_{(central tap)} and V_{(analog supply)} values of ˜2.5V. Thus, conventional GE systems typically do not utilize any transmit output power backoff during non-transmit operations. Without some sort of backoff, the voltage requirements are derived from a worst-case scenario, where a short cable Rx signal includes line driver output at a voltage of 2Vₚₜₚ. With no power backoff, voltage requirements for the GE system are derived from a worst-case, non-optimal scenario. Such scenarios generally increase line driver power consumption, without achieving a significant performance gain.

The present invention, in contrast, does provide a Tx power backoff scheme. This scheme significantly reduces the transmit (Tₓ) output swing for short transmission distances, and uses a high voltage swing for long transmission distances. In a short transmission distance application, Tx swing is low (<<1 Volt), and Rx voltage is high (>>1 Volt). In a long transmission distance application, just the opposite is true.

Under the present invention, a current mode line driver would require a central tap voltage as follows:
V_{(central tap)}=V_{Tx}+V_{Rx}+BLW margins+transistor margins=<<1 V+1 V+margins<2.5 V; (1)
where the central tap voltage may approach a value as low as 1.8 V. Similarly, a synthesized impedance voltage mode line driver would require an analog supply voltage as follows:
V_{(analog supply)}=V_{Tx}+V_{Rx}+BLW margins+transistor margins=<<1 V+1 V+margins<2.5 V; (2)
where the analog supply voltage may also approach a value as low as 1.8 V. Within this system of the present invention, an estimating construct resides somewhere within the PHY layer components, adapted to estimate or look-up cable length for a given application in start-up mode.

The system of the present invention thereby decreases—relatively—draw on central tap voltage or analog supply voltage—providing a reduced power-consumption line driver. A system according to the present invention thus experiences power savings even if a PHY device on the other end of a cable does not use the same scheme. The system of the present invention provides voltages lower than 1 V without compromising Rx performance of a PHY component. The system of the present invention also provides voltages lower than 1 V in short cable applications to a PHY component at the other end of a cable—where the component at the other end may receive a low voltage signal typical of longer cables, but having well defined shaping of short cables. In certain embodiments where it may be desirable to avoid interoperability issues for non-robust PHY component on the other end of a cable, the present invention may provide a pre-equalization construct. This pre-equalization construct may be provided to emulate a signal typically received from a longer cable suited to the low Tx voltage supplied by the system.

In certain embodiments, the system of the present invention may be provided to reduce the physical silicon area of a line driver. In such embodiments, central tap voltage (for current mode) or analog supply voltage (for voltage mode) may be maintained while line driver transistor size is reduced. This is made possible due to the smaller voltage swing associated therewith. The present invention thereby creates a trade-off between power reduction and area reduction—through which designers can optimize system performance in a desired manner.

Furthermore, the system of the present invention may be provided to interoperate from GE auto negotiation mechanisms. Typically, auto negotiation initiates with the backoff construct disabled. The power of far end auto negotiation pulses may be measured, and used to estimate cable length—either as the estimating construct or in cooperation with the estimating construct. A determination of optimal line driver back off is derived by a calculation construct, based upon the estimated cable length. During auto negotiation, an Ethernet port will declare its power reduction capabilities, and notify the far end componentry whether it will activate the backoff construct. If backoff is to be initiated, far end componentry will be provided with data characterizing the changes associated with the backoff. The backoff construct is activated only after auto negotiation is concluded.

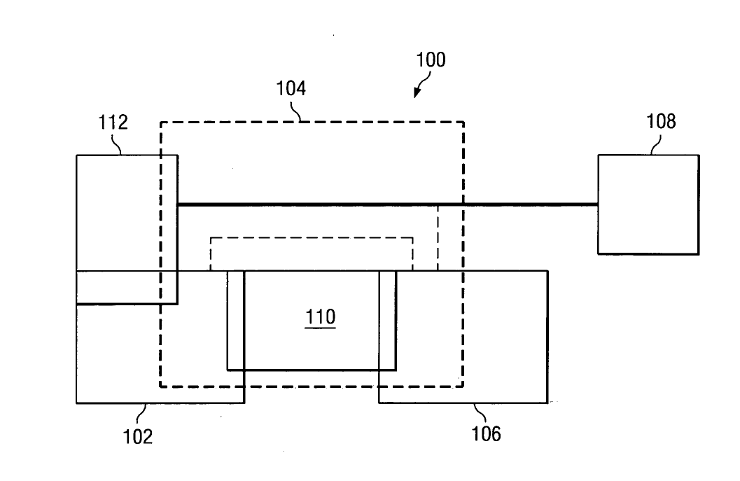

Finally, certain aspects of the present invention are described now in reference to FIG. 1, which depicts one illustrative functional diagram of a GE system 100 in accordance with the present invention. System 100 comprises a backoff construct 102, provided at least partially, if not fully, within a PHY operational layer 104. Construct 102 interoperates with a GE auto negotiation mechanism 106, which is also provided at least partially within PHY layer 104. An Ethernet port associated with the component housing PHY 104 is communicatively coupled to some other end or far end component 108. As indicated above, auto negotiation mechanism 106 may interact with component 108 concerning activation of construct 102, depending upon the particular embodiment of system 100.

System 100 further comprises an estimating construct 110, which is provided at least partially within PHY layer 104, and may be wholly or partially integrated with mechanism 106 or construct 102, in a functional or physical sense. Depending upon the embodiment, system 100 may further comprise an equalization construct 112 that may be independent of, or partially or wholly integrated with, construct 102.

In all embodiments of the present invention, the constituent constructs, routines, functions or components may be implemented in a wide variety of ways—comprising various suitable software, firmware or hardware constructs, or combinations of thereof. For example, certain algorithms and routines described herein may comprise firmware or separate code segments, grouped together in functional segments, or incorporated as part of a larger integrated code segment. They may comprise software operating on a host computer system, or routines operating on a digital signal processor. Certain functions or operations may be provided in exclusively in hardware. All of these variations, and all other similar variations and combinations, are comprehended by the present invention. All such embodiments may be employed to provide the benefits of the present invention.

The embodiments and examples set forth herein are therefore presented to best explain the present invention and its practical application, and to thereby enable those skilled in the art to make and utilize the invention. However, those skilled in the art will recognize that the foregoing description and examples have been presented for the purpose of illustration and example only. The teachings and principles of the present invention are applicable to a number of digital communications technologies. The description as set forth herein is therefore not intended to be exhaustive or to limit the invention to the precise form disclosed. As stated throughout, many modifications and variations are possible in light of the above teaching without departing from the spirit and scope of the following claims.

What is claimed is:

1. An Ethernet-based communications system comprising:
a PHY operational layer;
a backoff construct provided at least partially within the PHY operational layer;
an other end component communicatively coupled to the PHY operational layer; and
an estimating construct provided with the PHY operational layer and cooperatively associated with the backoff construct;
wherein the estimating construct determines whether the other end component is at a short or a long distance and, responsive to that determination, the backoff construct adjusts transmit output voltage swing.

2. The system of claim 1, wherein the Ethernet-based communications system comprises a Gigabit Ethernet system.

3. The system of claim 1, further comprising an auto negotiation mechanism provided at least partially within the PHY operational layer and operatively associated with the backoff construct.

4. The system of claim 1, further comprising an equalization construct provided at least partially within the PHY operational layer, communicatively coupled to the other end component, and operatively associated with the backoff construct.

5. The system of claim 3, wherein the estimating construct is provided at least partially within the auto negotiation mechanism.

6. The system of claim 3, wherein the estimating construct is provided within the auto negotiation mechanism.

7. A method of optimizing transmission output power consumption for a Gigabit Ethernet communications system, the method comprising the steps of:
providing a PHY operational layer associated with a first Ethernet component;
providing a backoff construct, at least partially implemented within the PHY operational layer;
providing a second Ethernet component communicatively coupled to the PHY operational layer;
providing an estimating construct, at least partially implemented within the PHY operational layer, and cooperatively associated with the backoff construct;
utilizing the estimating construct to determine whether the second Ethernet component is at a short or a long distance from the first Ethernet component; and
utilizing the backoff construct to adjust, responsive to a determination of the estimating construct, transmit output voltage swing.

8. The method of claim 7, wherein the step of utilizing the backoff construct to adjust the transmit output voltage swing further comprises utilizing the backoff construct to adjust the transmit output voltage swing to less than 2 Volts.

9. The method of claim 7, wherein the step of utilizing the backoff construct to adjust the transmit output voltage swing further comprises utilizing the backoff construct to adjust the transmit output voltage swing to approximately 1.8 Volts.

10. The method of claim 7, wherein the step of providing a backoff construct further comprises providing a backoff construct implemented using hardware.

11. The method of claim 7, wherein the step of providing a backoff construct further comprises providing a backoff construct implemented using software.

12. The method of claim 7, further comprising the step of providing an auto negotiation mechanism at least partially implemented within the PHY operational layer, and operatively associated with the backoff construct.

13. The method of claim 7, further comprising the step of providing an equalization construct at least partially implemented within the PHY operational layer, communicatively coupled to the second Ethernet component, and operatively associated with the backoff construct.

14. The method of claim 12, wherein the step of providing an estimating construct further comprises providing an estimating construct at least partially implemented within the auto negotiation mechanism.

15. The method of claim 12, wherein the step of providing an estimating construct further comprises providing an estimating construct implemented within the auto negotiation mechanism.
